(19) United States
(12) Patent Application Publication
(10) Pub. No.: US 2007/0229405 A1
(43) Pub. Date: Oct. 4, 2007

(54) Plasma display apparatus and driving method thereof

(75) Inventor: Seong Hak Moon, Seoul (KR)

Correspondence Address: KED & ASSOCIATES, LLP, P.O. Box 221200, Chantilly, VA, 20153-1200, US

(73) Assignee: LG Electronics Inc.

(21) Appl. No.: 11/730,688

(22) Filed: Apr. 3, 2007

(30) Foreign Application Priority Data
Apr. 4, 2006 (KR) 10-2006-0030587
Apr. 4, 2006 (KR) 10-2006-0030590

(51) Int. Cl. G09G 3/28

(52) U.S. Cl. 345/60

(57) ABSTRACT

A plasma display apparatus comprises a controller receiving and processing the same image signal during each unit period, a plasma display panel including a discharge cell corresponding to an area where a first electrode and a second electrode, and displaying an image corresponding to the same image signal, a first electrode driver supplying a data pulse corresponding to a variation of a grey level of the discharge cell to the first electrode when an accumulation time of the unit period is greater than a reference time and a second electrode driver supplying the same number of sustain pulses to the plurality of second electrodes during each unit period.

This application claims the benefit of Korean Patent Application Nos. 10-2006-0030587 and 10-2006-0030590 filed on Apr. 04, 2006, which is hereby incorporated by reference.

### BACKGROUND

1. Field

This document is related to a plasma display apparatus and a driving method of the plasma display apparatus.

2. Description of the Related Art

A plasma display apparatus includes a plasma display panel and a driver. The plasma display panel includes a discharge cell partioned by a barrier rib. The driver supplies a driving signal to an electrode of the plasma display panel. As a result of a supply of the driving signal, a discharge occurs in the discharge cell, and excites a phosphor of the discharge cell. When the discharge excites the discharge cell, the phosphor generates light.

The plasma display apparatus achieves grey levels with a combination of subfields. The plasma display apparatus emits light during each subfield, and the grey levels are achieved by a sum of light amount emitted during each subfield.

Each subfield includes a reset period, an address period, and a sustain period. During the reset period, wall discharges of entire discharge cells of the plasma display panel are uniformed. Some discharge cells of the entire discharge cells are selected during the address period. The selected discharge cells emit light during the sustain period.

### SUMMARY

A plasma display apparatus comprises a controller receiving and processing the same image signal during each unit period, a plasma display panel including a discharge cell corresponding to an area where a first electrode and a second electrode, and displaying an image corresponding to the same image signal, a first electrode driver supplying a data pulse corresponding to a variation of a grey level of the discharge cell to the first electrode when an accumulation time of the unit period is greater than a reference time and a second electrode driver supplying the same number of sustain pulses to the plurality of second electrodes during each unit period.

A plasma display apparatus comprises a plasma display panel including a discharge cell corresponding to an area where a first electrode and a second electrode, a calculator outputting a first signal corresponding to a time when the discharge cell emits light, a compensator outputting a second signal representing an variation ratio of grey level corresponding to the discharge cell when the time corresponding to the first signal is greater than a reference time, an image data processor outputting a display image signal changed from an image signal according to the second signal and a first electrode driver supplying a data pulse corresponding to the display image signal to the first electrode.

A driving method of a plasma display apparatus including a discharge cell corresponding to an area where a first electrode and a second electrode, comprises outputting a first signal corresponding to a time when the discharge cell emits light, supplying a second signal representing an variation ratio of grey level corresponding to the discharge cell when the time corresponding to the first signal is greater than a reference time, outputting a display image signal changed from the image signal according to the second signal and supplying a data pulse corresponding to the display image signal to the first electrode.

### BRIEF DESCRIPTION OF THE DRAWINGS

The embodiment will be described in detail with reference to the following drawings in which like numerals refer to like elements.

FIG. 1 illustrates a plasma display apparatus according to an embodiment;

FIGS. 2a to 2c are for describing variation of grey level;

FIG. 3 illustrates a decrease ratio of brightness according to a phosphor;

FIG. 4 illustrates an achieving method of of grey level of plasma display apparatus; and

FIG. 5 describes an operation example of the plasma display apparatus according to the embodiment.

### DETAILED DESCRIPTION OF EMBODIMENTS

In one aspect, a plasma display apparatus comprises a controller receiving and processing the same image signal during each unit period, a plasma display panel including a discharge cell corresponding to an area where a first electrode and a second electrode, and displaying an image corresponding to the same image signal, a first electrode driver supplying a data pulse corresponding to a variation of a grey level of the discharge cell to the first electrode when an accumulation time of the unit period is greater than a reference time and a second electrode driver supplying the same number of sustain pulses to the plurality of second electrodes during each unit period.

The unit period may be a frame.

The unit period may be a frame, and the number of sustain pulses assigned to each subfield of each frame is constant.

The plasma display panel may include two adjacent discharge cells corresponding to the second electrode and the two first electrodes, and the first electrode driver may supply the data pulses corresponding to variations of grey levels of the two discharge cells to the two first electrodes.

The plasma display panel may include a first discharge cell and a second discharge cell corresponding to the two first electrodes, and the first electrode driver may supply the data pulses, which make a variation ratio of grey level corresponding to the first discharge cell different from a variation ratio of grey level corresponding to the second discharge cell, to the two first electrodes.

The plasma display panel may include a first discharge cell, a second discharge cell, and a third discharge cell, which respectively emits red light, green light, and blue light, corresponding to the three first electrodes, and the first electrode driver may supply the data pulses, which make a variation ratio of grey level corresponding to the second discharge cell greater than variation ratios of grey levels corresponding to the first and the third discharge cells, to the three first electrodes.

In another aspect, a plasma display apparatus comprises a plasma display panel including a discharge cell corresponding to an area where a first electrode and a second electrode, a calculator outputting a first signal corresponding to a time when the discharge cell emits light, a compensator outputting a second signal representing an variation ratio of grey level corresponding to the discharge cell when the time corresponding to the first signal is greater than a reference time, an image data processor outputting a display image signal changed from an image signal according to the second signal and a first electrode driver supplying a data pulse corresponding to the display image signal to the first electrode.

The plasma display apparatus further may comprise a memory storing a decrease ratio of brightness according to the time and the variation ration of grey level corresponding to the brightness decrease ratio.

The calculator may output the first signal by a frame.

The plasma display panel may include two discharge cells corresponding to the second electrode and the two first electrodes, and the first electrode driver may supply the data pulses, which varies grey levels corresponding to the two discharge cells, to the two first electrodes.

The plasma display panel may include a first discharge cell and a second discharge cell corresponding to the two first electrodes, and the first electrode driver supplies the data pulses, which make a variation ratio of grey level corresponding to the first discharge cell different from a variation ratio of grey level corresponding to the second discharge cell, to the two first electrodes.

The plasma display panel may include a first discharge cell, a second discharge cell, and a third discharge cell, which respectively emits red light, green light, and blue light, corresponding to the three first electrodes, and the first electrode driver may supply the data pulses, which make a variation ratio of grey level corresponding to the second discharge cell greater than variation ratios of grey levels corresponding to the first and the third discharge cells, to the three first electrodes.

The calculator may receive a light emission signal from a sensor sensing light emitted by the discharge cell, and may output the first signal.

In still another aspect, a driving method of a plasma display apparatus including a discharge cell corresponding to an area where a first electrode and a second electrode, comprises outputting a first signal corresponding to a time when the discharge cell emits light, supplying a second signal representing an variation ratio of grey level corresponding to the discharge cell when the time corresponding to the first signal is greater than a reference time, outputting a display image signal changed from the image signal according to the second signal and supplying a data pulse corresponding to the display image signal to the first electrode.

The first signal may be output by a frame.

The plasma display apparatus may include two discharge cells corresponding to the second electrode and the two first electrodes, and the two first electrodes may receive the data pulses which vary grey levels corresponding to the two discharge cells.

The plasma display apparatus may include a first discharge cell and a second discharge cell corresponding to the two first electrodes, and the two first electrodes may receive the data pulses which make a variation ratio of grey level corresponding to the first discharge cell different from a variation ratio of grey level corresponding to the second discharge cell.

The plasma display apparatus may include a first discharge cell, a second discharge cell, and a third discharge cell, which respectively emits red light, green light, and blue light, corresponding to the three first electrodes, and the three first electrodes may receive the data pulses which make a variation ratio of grey level corresponding to the second discharge cell greater than variation ratios of grey levels corresponding to the first and the third discharge cells.

The time when the discharge cell emits light may be calculated through a light emission signal outputted when the light is sensed.

Embodiments will be described in a more detailed manner with reference to the drawings.

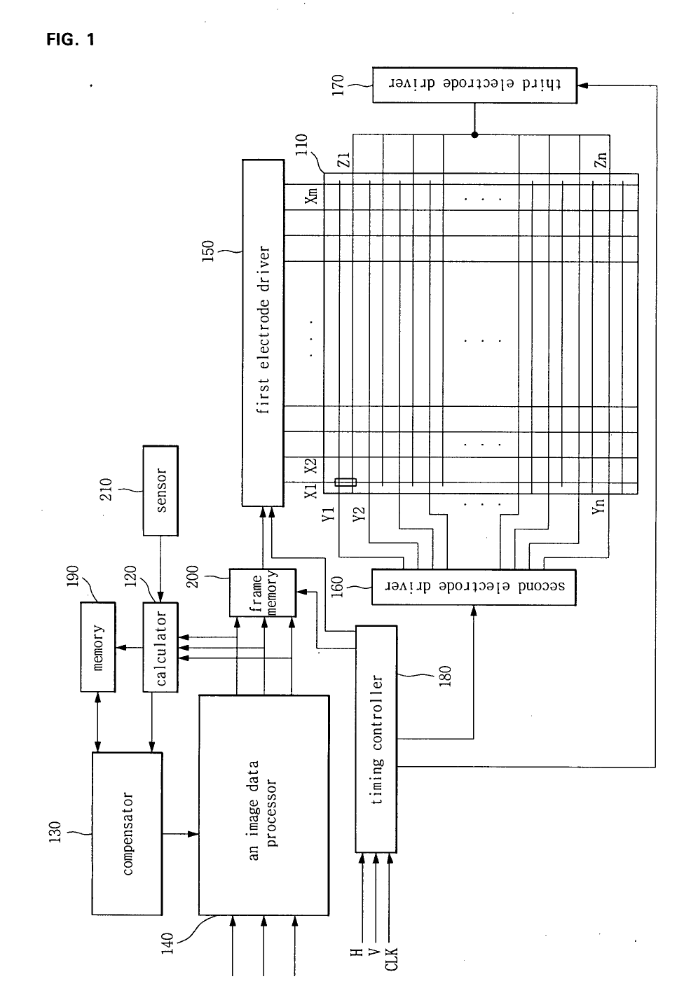

FIG. 1 illustrates a plasma display apparatus according to an embodiment. As illustrated in FIG. 1, the plasma display apparatus according to the embodiment comprises a plasma display panel 110, a calculator 120, a compensator 130, an image data processor 140, a first electrode driver 150, a second electrode driver 160, a third electrode driver 170, and a timing controller 180.

The plasma display panel 110 includes a discharge cell corresponding to an area where a first electrode X1-Xm and a second electrode Y1-Yn cross. A third electrode Z1-Zn is parallel to the second electrode Y1-Yn. Each discharge cell is portioned by a barrier rib, and a phosphor is positioned inside the barriers.

A calculator 120 outputs a first signal corresponding to a time when the discharge cell emits light.

A compensator 130 outputs a second signal representing an variation ratio of grey level corresponding to the discharge cell when the time corresponding to the first signal is greater than a reference time.

An image data processor 140 outputs a display image signal changed from an image signal according to the second signal. The image data processor 140 performs a reverse gamma correction process, a half-toning process, a subfield mapping process, and a data arrange process. Accordingly, it is defined whether light emits from each discharge cell or not in each subfield. The calculator 120 receives the display image signal, and calculates the time when each discharge cell emits light. The display image signal output by the image data processor 104 corresponds to the first signal of the calculator 120.

The first electrode driver 150 supplies a data pulse corresponding to the display image signal to the first electrode X1-Xm.

The second electrode driver 160 supplies a scan pulse synchronized with the data pulse to the second electrode Y1-Yn.

The second electrode driver 160 and the third electrode driver 160 alternately supply sustain pulses, which make light emitted from discharge cell selected by the data pulse and the scan pulse, to the second electrode Y1-Yn and the third electrode Z1-Zn.

The timing controller 180 receives a horizontal synchronization signal H, a vertical synchronization signal V, a clock signal CLK, and outputs timing signals for controlling an operation of the calculator 120, the compensator 130, the image data processor 140, the first electrode driver 150, the second electrode driver 160 and the third electrode driver 170.

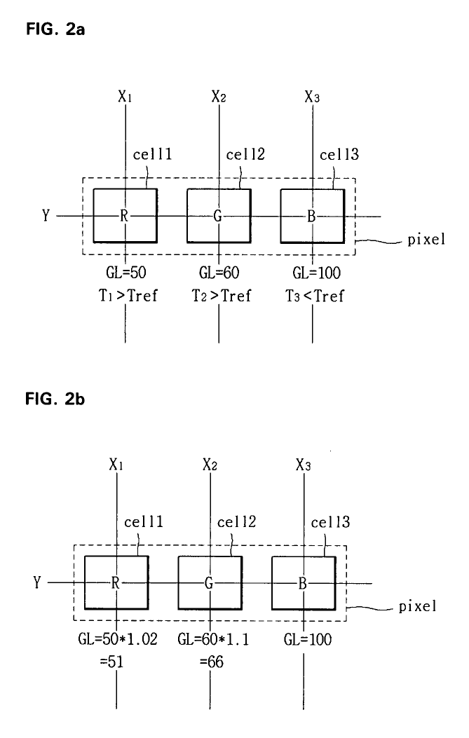

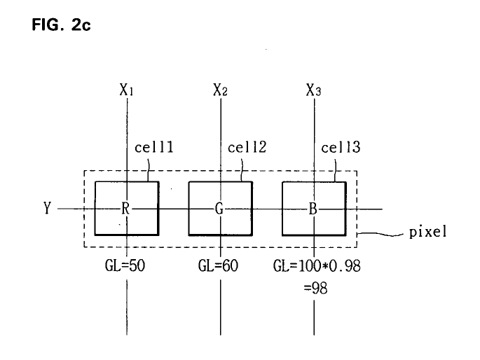

FIGS. 2a to 2c are for describing variation of grey level. As illustrated in FIGS. 2a and 2b, the plasma display panel of the plasma display apparatus according to the embodiment includes a first discharge cell cell1, a second discharge cell cell2, and a third discharge cell cell3 corresponding to areas where the first electrodes X1, X2, and X3 and the second electrode Y corss. Red phosphor, green phosphor, and blue phosphor are positioned inside the three discharge cells cell1, cell2, cell3 consisting one pixel. Accordingly, the three discharge cells cell1, cell2, cell3 respectively emit red light, green light, and blue light.

In FIG. 2a, the first discharge cell cell1, image signals of the second discharge cell cell2 and the third discharge cell cell3 respectively corresponds to grey level 50, grey level 60 and grey level 100. Times T1, T2 when the first discharge cell cell1 and the second discharge cell cell2 emit light are greater than a reference time Tref, and time T3 when the third discharge cell cell3 emits light is less than a reference time Tref. Accordingly, due to a degradation of the red phosphor of the first discharge cell cell1 and the green phosphor of the second discharge cell cell2, an amount of light which the first discharge cell cell1 and the second discharge cell cell2 emit decreases. As the amount of the first discharge cell cell1 and the second discharge cell cell2 decreases, a color temperature or a color coordinate of the light emitted from the pixel are failed, and an image quality becomes degraded.

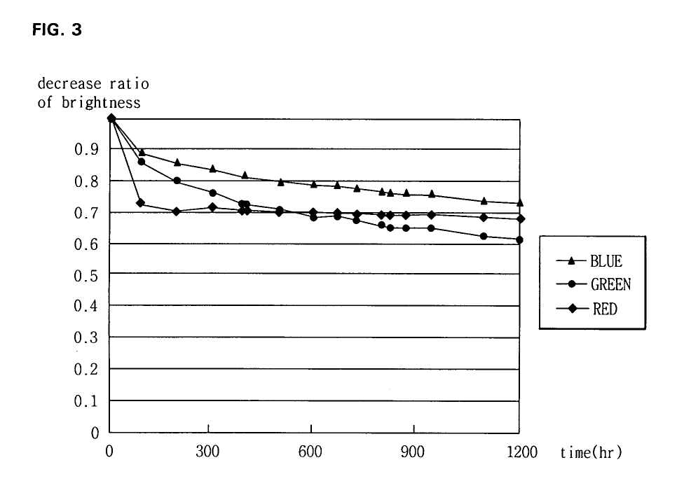

FIG. 2b illustrates an increase of grey levels GL of the first discharge cell cell1 and the second discharge cell cell2 according to the second signal output from the compensator 130. The increase of grey level GL depends on a variation ratio of grey level such as 1.02 or 1.1. Because the amount of light which the first discharge cell cell1 and the second discharge cell cell2 emit decreases due to the degradation of the phosphor, the amount of light is compensated through the increase of grey level GL. Accordingly, the color temperature and the color coordinate of the light which the pixel emits are sustained. Grey levels 51, 66 correspond to the display image signal. As illustrated in FIG. 3, a decrease ratio of a brightness of the green phosphor is greater than a decrease ration of a brightness of the red phosphor or the blue phosphor. Accordingly, the variation of grey level of the second discharge cell cell2 is greater than the variation of grey level of the first discharge cell cell1.

FIG. 2c illustrates a decrease of grey level GL of the second discharge cell and the third discharge cell cell2 and cell3 according to the second signal output from the compensator. The decrease of grey level GL also depends on the variation of grey level such as 0.98. Because the amount of light which the first discharge cell cell1 and the second discharge cell cell2 emit decreases due to the degradation of the phosphor, the amount of light is compensated through the decrease of grey level GL of the third discharge cell cell3. Accordingly, the color temperature and the color coordinate of the light which the pixel emits are sustained. Grey level 98 corresponds to the display image signal.

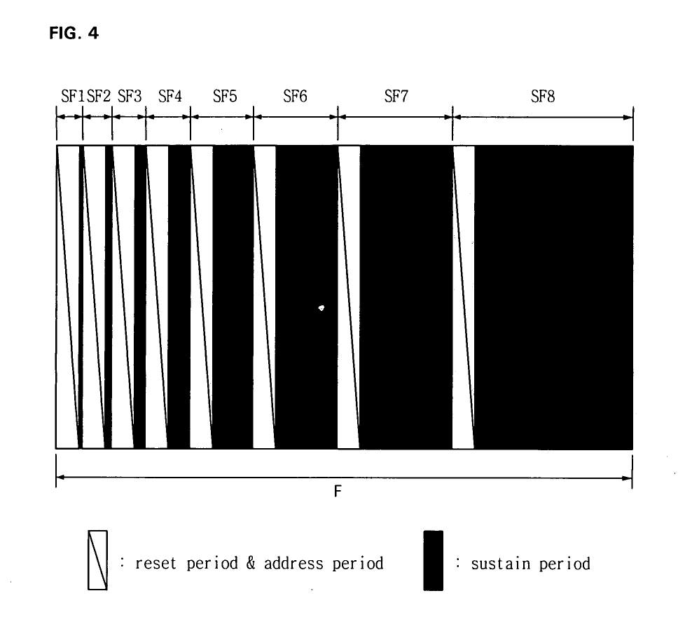

FIG. 4 illustrates an achieving method of of grey level of plasma display apparatus. As illustrated in FIG. 4, one frame includes a plurality of subfields SF1-SF8. Each subfield includes a reset period, an address period, and a sustain period. The sustain period of subfield is proportional to a weight of grey level of subfield. A grey level corresponding to a discharge cell is mapped to at least one of the plurality of subfields, and the grey level is achieved by an emission of the discharge during the subfield.

For example, each weight of the plurality of subfields SF1-SF8 is respectively 2⁰, 2¹, 2², 2³, 2⁴, 2⁵, 2⁶, and 2⁷, the grey level 50(=2¹+2⁴+2⁵) of the first discharge cell cell1 of FIG. 2a is mapped to SF2, SF5 and SF6. The grey level 60(=2²+2³+2⁴+2⁵) of the second discharge cell cell2 of FIG. 2a is mapped to SF3, SF4, SF5, and SF6. The grey level 100(=2²+2⁵+2⁶) of the third discharge cell cell3 of FIG. 2a is mapped to SF3, SF6 and SF7.

The grey level 51(=2⁰+2¹+2⁴+2⁵) of the first discharge cell cell1 of FIG. 2b is mapped to SF1, SF2, SF5 and SF6. The grey level 66(=2¹+2⁶) of the second discharge cell cell2 of FIG. 2b is mapped to SF2 and SF7. The grey level 100(=2²+2⁵+2⁶) of the third discharge cell cell3 of FIG. 2b is mapped to SF3, SF6 and SF7.

The grey level 50(=2¹+2⁴+2⁵) of the first discharge cell cell1 of FIG. 2c is mapped to SF2, SF5 and SF6. The grey level 60(=2²+2³+2⁴+2⁵) of the second discharge cell cell2 of FIG. 2c is mapped to SF3, SF4, SF5, and SF6. The grey level 98(=2¹+2⁵+2⁶) of the third discharge cell cell3 of FIG. 2c is mapped to SF2, SF6 and SF7.

The first electrode driver 150 supplies data pulses having high level to a first electrode X1 corresponding to the first discharge cell cell1 during each address period of subfields SF2, SF5 and SF6. In case that the time when the first discharge cell cell1 emits light is greater than the reference time, the first electrode driver 150 supplies data pulses having high level to the first electrode X1 corresponding to the first discharge cell cell1 during each address period of subfields SF1, SF2, SF5 and SF6. Because a subfield mapping varies according to the variation of grey level, the first electrode driver 150 supplies data pulses according to the variation of the subfield mapping.

An operation of the plasma display apparatus according to the embodiment will be described in detail with reference to a figure.

A calculator 120 receives an display image signal from an image data processor 140, and outputs a first signal corresponding to a time when the discharge cell emits light. For example, the calculator 120 may output the first signal corresponding to a sum of a unit period when the discharge cell emits light. The calculator 120 may output the first signal during each frame. Because the image data processor 140 receives an image signal during each frame, the calculator 120 may output the first signal by a frame. Accordingly, a calculation load of the calculator 120 decreases.

A memory 190 receives the first signal, and stores an information of the first signal. The memory 190 stores a look up table corresponding to a decrease ratio of brightness according to the time and the variation ration of grey level corresponding to the decrease ratio of brightness. The look up table represents a relation of the time and the decrease ratio of brightness.

When the time corresponding to the first signal is greater than the reference time, the compensator 130 receives a variation ratio of grey level according to the time, and outputs a second signal representing the variation ration of grey level corresponding to each discharge cell. The compensator 130 outputs the second signal for compensating variation of brightness.

An image data processor 140 outputs a display image signal changed from the image signal according to the second signal. For example, as illustrated in FIG. 2b, image data processor 140 calculates grey level 51 with a grey level 50 of the image signal of the first discharge cell cell1 and the variation ratio 1.02 of grey level corresponding to the second signal, and performs a subfield mapping process of the grey level 51. The image data processor 140 generates the display image signal through a data arrange process after the subfield mapping process.

A frame memory 200 stores the display image signal temporarily, and the display image signal to the first electrode driver 150 according to a timing control signal output from a timing controller.

The first electrode driver 150 supplies a data pulse corresponding to the display image signal to the first electrode X1-Xm. The first electrode driver 150 supplies the data pulse corresponding to the display image signal to the first electrode X1-Xm.

A plasma display panel 110 comprises two discharge cells corresponding to the second electrode and the two first electrodes, and the first electrode driver 150 may supply data pulses varying grey levels corresponding to the two discharge cells. For example, as illustrated in FIGS. 2a and 2b, the first electrode driver 150 data pulses to the two first electrodes X1 and X2. The data pulses supplied to the two first electrodes X1 and X2 correspond to grey levels 51 and 66 of the display imagel signal changed from grey levels of the image signal 50 and 60 corresponding to the first cell cell1 and the second discharge cell cell2. Accordingly, the grey levels corresponding to two discharge cells positioned on the second electrode Y is varied.

The plasma display panel 100 includes a first discharge cell and a second discharge cell corresponding to the two first electrodes, and the first electrode driver 150 supplies the data pulses, which make a variation ratio of grey level corresponding to the first discharge cell different from a variation ratio of grey level corresponding to the second discharge cell, to the two first electrodes. For example, as illustrated in FIGS. 2a and 2b, when the display image signal is generated by the image signal corresponding to the first discharge cell cell1 and the second discharge cell cell2, the variation ratio 1.02 of grey level of the first discharge cell cell1 is different from the variation 1.1 of grey level of the second discharge cell cell2. Accordingly, the first electrode driver 150 may supply data pulses corresponding to grey level 51 and 66 to the two first electrode corresponding to the first discharge cell1 and the second discharge cell cell2. In case that the variation ratios of grey level of discharge cells are different each other, a color coordinate and a color temperature according to phosphor characteristic can be sustained.

The plasma display panel 100 includes a first discharge cell, a second discharge cell, and a third discharge cell, which respectively emits red light, green light, and blue light, corresponding to the three first electrodes, and the first electrode driver 150 supplies the data pulses, which make a variation ratio of grey level corresponding to the second discharge cell greater than variation ratios of grey levels corresponding to the first and the third discharge cells, to the three first electrodes. For example, as illustrated in FIG. 2b, when the display image signal is generated by the image signal corresponding to the discharge cells cell1, cell2, and cell3, the variation ratio of grey level of the second discharge cell cell2 is greater than the variation ratios of grey level of the first and the third discharge cells cell1 and cell3. Accordingly, the first electrode driver 150 can supply the data pulses corresponding to grey levels 51, 66, and 100 of the display image signal to the three first electrodes X1, X2 and X3.

The calculator 120 may receive a light emission signal from a sensor 210 sensing light emitted by the discharge cell, and outputs the first signal. Because the sensor 210 senses the light emitted from the discharge cell, the calculator 120 can calculate time when the discharge cell emits the light through the light emission signal output by the sensor 210. Because the calculator 120 calculates the time with the light emission signal output by the sensor 210, the time when the discharge cell emits the light can be calculated exactly.

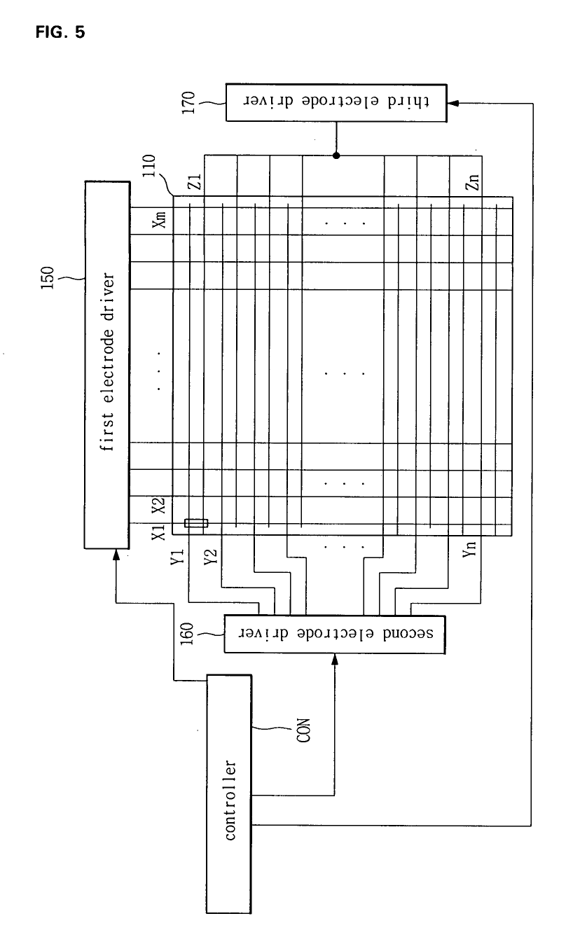

FIG. 5 describes an operation example of the plasma display apparatus according to the embodiment.

A controller CON receives and processes the same image signal during each unit period. For example, the controller CON receives and processes the same image signal during each frame. The controller CON includes the calculator 120, the compensator 130, the image data processor 140 and the timing controller of FIG. 1.

A plasma display panel 110 includes a discharge cell corresponding to an area where a first electrode X1-Xm and a second electrode Y1-Yn, and displays an image corresponding to the same image signal.

The first electrode driver 150 supplies a data pulse corresponding to a variation of a grey level of the discharge cell to the first electrode X1-Xm when an accumulation time of the unit period is greater than a reference time. For example, in case that the duration of the reference time is 10 frames and the duration of the time when the image corresponding the same image signal is displayed on the plasma display panel 110 is less than 10 frames, the first electrode driver 150 supplies data pulse corresponding to the image signal to the first electrode X1-Xm. When the duration of the time when the image corresponding the same image signal is displayed on the plasma display panel 110 is greater than 10 frames, the first electrode driver 150 receives a display image signal changed from the grey level of the discharge cell from the controller CON, and supplies the data pulse corresponding to the display image signal to the first electrode X1-Xm.

The second electrode driver 160 supplies the same number of sustain pulses to the plurality of second electrodes during each unit period such as a frame. The number of sustain pulses assigned to each subfield of each frame may be constant. For example, in case that the number of sustain pulses assigned to n-th frame is 500, the number of sustain pulses assigned to (n+1)-th frame is 500. In case that the number of sustain pulses assigned to m-th subfield of n-th frame is 50, the number of sustain pulses assigned to m-th subfield of (n+1)-th frame is 50.

When the controller CON processes the same image signal and the second electrode driver 160 supplies the same number of sustain pulses to the second electrode Y1-Yn during each frame, the first electrode driver 150 supplies the data pulse corresponding to variation of grey level to sustain a color temperature and a color coordinate.

As described above with reference to FIGS. 2a to 2c, the first electrode driver 150 may supply the data pulses corresponding to variations of grey levels of the two discharge cells cell1 and cell2 to the two first electrodes X1 and X2. The first electrode driver 150 may supply the data pulses, which make a variation ratio of grey level corresponding to the first discharge cell cell1 different from a variation ratio of grey level corresponding to the second discharge cell cell2, to the two first electrodes X1 and X2. The first electrode driver 150 may supply the data pulses, which make a variation ratio of grey level corresponding to the second discharge cell cell2 greater than variation ratios of grey levels corresponding to the first and the third discharge cells cell1 and cell3, to the three first electrodes X1, X2 and X3.

The plasma display apparatus of FIG. 5 also may decide a variation of grey level according to the light emission signal of the sensor 210 described above. The operation of the sensor 210 is described above, thus being omitted.

The foregoing embodiments and advantages are merely exemplary and are not to be construed as limiting the present invention. The present teaching can be readily-applied to other types of apparatuses. The description of the foregoing embodiments is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures. Moreover, unless the term means is explicitly recited in a limitation of the claims, such limitation is not intended to be interpreted under 35 USC 112(6).

What is claimed is:

1. A plasma display apparatus comprising:
a controller receiving and processing the same image signal during each unit period;
a plasma display panel including a discharge cell corresponding to an area where a first electrode and a second electrode, and displaying an image corresponding to the same image signal;
a first electrode driver supplying a data pulse corresponding to a variation of a grey level of the discharge cell to the first electrode when an accumulation time of the unit period is greater than a reference time; and
a second electrode driver supplying the same number of sustain pulses to the plurality of second electrodes during each unit period.

2. The plasma display apparatus of claim 1, wherein
the unit period is a frame.

3. The plasma display apparatus of claim 1, wherein
the unit period is a frame, and
the number of sustain pulses assigned to each subfield of each frame is constant.

4. The plasma display apparatus of claim 1, wherein
the plasma display panel includes two adjacent discharge cells corresponding to the second electrode and the two first electrodes, and
the first electrode driver supplies the data pulses corresponding to variations of grey levels of the two discharge cells to the two first electrodes.

5. The plasma display apparatus of claim 1, wherein
the plasma display panel includes a first discharge cell and a second discharge cell corresponding to the two first electrodes, and
the first electrode driver supplies the data pulses, which make a variation ratio of grey level corresponding to the first discharge cell different from a variation ratio of grey level corresponding to the second discharge cell, to the two first electrodes.

6. The plasma display apparatus of claim 1, wherein
the plasma display panel includes a first discharge cell, a second discharge cell, and a third discharge cell, which respectively emits red light, green light, and blue light, corresponding to the three first electrodes, and
the first electrode driver supplies the data pulses, which make a variation ratio of grey level corresponding to the second discharge cell greater than variation ratios of grey levels corresponding to the first and the third discharge cells, to the three first electrodes.

7. A plasma display apparatus comprising:
a plasma display panel including a discharge cell corresponding to an area where a first electrode and a second electrode;
a calculator outputting a first signal corresponding to a time when the discharge cell emits light;
a compensator outputting a second signal representing an variation ratio of grey level corresponding to the discharge cell when the time corresponding to the first signal is greater than a reference time;
an image data processor outputting a display image signal changed from an image signal according to the second signal; and
a first electrode driver supplying a data pulse corresponding to the display image signal to the first electrode.

8. The plasma display apparatus of claim 7, further comprises a memory storing a decrease ratio of brightness according to the time and the variation ration of grey level corresponding to the brightness decrease ratio.

9. The plasma display apparatus of claim 7, wherein
the calculator outputs the first signal by a frame.

10. The plasma display apparatus of claim 7, wherein
the plasma display panel includes two discharge cells corresponding to the second electrode and the two first electrodes, and
the first electrode driver supplies the data pulses, which varies grey levels corresponding to the two discharge cells, to the two first electrodes.

11. The plasma display apparatus of claim 7, wherein
the plasma display panel includes a first discharge cell and a second discharge cell corresponding to the two first electrodes, and
the first electrode driver supplies the data pulses, which make a variation ratio of grey level corresponding to the first discharge cell different from a variation ratio of grey level corresponding to the second discharge cell, to the two first electrodes.

12. The plasma display apparatus of claim 7, wherein
the plasma display panel includes a first discharge cell, a second discharge cell, and a third discharge cell, which respectively emits red light, green light, and blue light, corresponding to the three first electrodes, and
the first electrode driver supplies the data pulses, which make a variation ratio of grey level corresponding to the second discharge cell greater than variation ratios of grey levels corresponding to the first and the third discharge cells, to the three first electrodes.

13. The plasma display apparatus of claim 7, wherein
the calculator receives a light emission signal from a sensor sensing light emitted by the discharge cell, and outputs the first signal.

14. A driving method of a plasma display apparatus including a discharge cell corresponding to an area where a first electrode and a second electrode, comprising:
outputting a first signal corresponding to a time when the discharge cell emits light;
supplying a second signal representing an variation ratio of grey level corresponding to the discharge cell when the time corresponding to the first signal is greater than a reference time;
outputting a display image signal changed from the image signal according to the second signal; and
supplying a data pulse corresponding to the display image signal to the first electrode.

15. The driving method of claim 14, wherein
the first signal is output by a frame.

16. The driving method of claim 14, wherein
the plasma display apparatus includes two discharge cells corresponding to the second electrode and the two first electrodes, and
the two first electrodes receive the data pulses which vary grey levels corresponding to the two discharge cells.

17. The driving method of claim 14, wherein
the plasma display apparatus includes a first discharge cell and a second discharge cell corresponding to the two first electrodes, and
the two first electrodes receive the data pulses which make a variation ratio of grey level corresponding to the first discharge cell different from a variation ratio of grey level corresponding to the second discharge cell.

18. The driving method of claim 14, wherein
the plasma display apparatus includes a first discharge cell, a second discharge cell, and a third discharge cell, which respectively emits red light, green light, and blue light, corresponding to the three first electrodes, and
the three first electrodes receive the data pulses which make a variation ratio of grey level corresponding to the second discharge cell greater than variation ratios of grey levels corresponding to the first and the third discharge cells

19. The driving method of claim 14, wherein
the time when the discharge cell emits light is calculated through a light emission signal outputted when the light is sensed.
